(19) United States
(12) Patent Application Publication
(10) Pub. No.: US 2002/0116620 A1
(43) Pub. Date: Aug. 22, 2002

(54) System and method for collaboration between regulatory agency and regulated entity

(76) Inventors: Norman Wesley Gimbert, Cincinnati, OH (US); Kevin Bruce Webster, Hamilton, OH (US)

Correspondence Address: BARBARA JOAN HAUSHALTER, LAW OFFICE, 228 BENT PINES CT., BELLEFONTAINE, OH, 43311, US

(21) Appl. No.: 09/780,813

(22) Filed: Feb. 9, 2001

Related U.S. Application Data
(60) Provisional application No. 60/242,790, filed on Oct. 24, 2000.

(51) Int. Cl. H04L 9/00; H04K 1/00

(52) U.S. Cl. 713/185; 705/64

(57) ABSTRACT

A computer-implemented system and method of secure transmission and collaboration of information between the employees of an entity and a regulator agency for the purpose of obtaining disposition by the regulatory agency. The system consists of a connected web sever and a database, both of which are protected behind at least one firewall. The web server and the multifunctional database are hosted and maintained by the entity for use by the regulatory agency and connects the employees of an agency and employees of the regulatory agency. The web server utilizes a security system to allow access to various functions of the system according to identity of the user.

### CROSS REFERENCE TO RELATED APPLICATION

This application claims the benefit of U.S. Provisional Application No. 60/242,790, filed Oct. 24, 2000.

### BACKGROUND OF THE INVENTION

This invention relates generally to a system and method for collaboration between the employees of an entity and employees of a regulator agency for the purpose of obtaining disposition by the regulatory agency.

Documents transferred to a regulatory agency by an entity subject to the agency's regulation for disposition may contain sensitive information. Therefore, the transferring entities want to ensure the confidentiality, authenticity, and the integrity of the documents' contents. As well, documents necessary for regulator disposition of a product or service can be voluminous.

Generally speaking, documents can be securely transmitted by two computer-implemented methods. Documents could be transmitted through a secure line or using encryption technologies to make the content of the document only readable to a receiving party with an encryption key. The first method involves transmitting the document via electronic mail attachments through a dedicated secure line. This method can be costly due to the installation and maintenance of the secure line. The second method involves encryption technology, which can be complex and time consuming. The transferring party encrypting the document must first transfer the encryption key to the receiving agency and then encrypt all documents into ciphertext before sending. Because encryption technology is a fairly recent technology either the transferring entity or receiving regulatory agency may be unfamiliar or unskilled in utilizing the second method. The encryption process is made more cumbersome due to the sheer volume of documents required for the disposition of products or services by a regulatory agency. Accordingly, it would be desirable to have an efficient method to communicate, collaborate, and transfer documents rapidly and securely between an entity and a regulatory agency.

### BRIEF SUMMARY OF THE INVENTION

The above-mentioned need is met by the present invention, which provides a computer-implemented system and method of secure transmission and collaboration of information between the employees of an entity and a regulator agency for the purpose of obtaining disposition by the regulatory agency. The system consists of a connected web server and a database, both of which are protected behind at least one firewall. The web server and the multifunctional database are hosted and maintained by the entity for use by the regulatory agency and connect the employees of an entity and the employees of the regulatory agency. The web server utilizes a security system, such as a collection of usernames and passwords, to allow access to various functions of the system according to the identity of the user. The system preferably includes a standard web-based security environment implemented in a commercially-available web browser to make encryption of communications simple for the user and without requiring additional software or system configuration.

The computer-implemented system and method allow the employees of both the entity and the regulatory agency to collaborate in creating, editing, storing and retrieving documents concerning regulatory disposition. The system and method allow data to be securely accessed by the employees of the entity and the regulator agency to check on submitted documents, retrieve answers to questions, and access a library of materials. Individual users have a personalized task list associated with their identity that is displayed when the user enters their username and password into the system. The tasks are assigned by other users and these tasks concern obtaining disposition from the regulatory agency, as well as providing other required information. The system uses an automatic electronic mail program to notify selected users information concerning a modification of a document's status as well as a hypertext link to the modified document. The parties can access relevant documents through either a hypertext link in their e-mail notification or by a link on their personal task list.

The present invention and its advantages over the prior art will become apparent upon reading the following detailed description and the appended claims with reference to the accompanying drawings.

### BRIEF DESCRIPTION OF THE DRAWINGS

The subject matter which is regarded as the invention is particularl pointed out and distinctly claimed in the concluding part of the specification. The invention, however, may be best understood by reference to the following description taken in conjunction with the accompanying drawing figures in which:

FIG. 1 is a block diagram illustrating an embodiment of the present invention.

FIG. 2 is a flow diagram of a method of using a computer implemented system according to the present invention.

### DETAILED DESCRIPTION OF THE INVENTION

The present invention provides a computer implemented system and method of secure transmission and collaboration of information between the employees of an entity and the employees of a regulatory agency for the purpose of obtaining disposition by a regulatory agency. As utilized herein, the term “disposition” encompasses a variety of positions that a regulatory agency can take with regard to an individual item of documentation or information, or a product or service, such as “close”, “concur”, “acknowledge”, “approve”, etc. The system and method facilitate secure electronic communications and collaboration between an entity and a regulatory agency using standard web-based security measures without the expense of installing a dedicated line between the two parties or use of complicated encryption technology.

The term “entity”, as used herein, includes: corporations whether foreign or domestic; profit and not-for-profit; unincorporated associations; businesses; estates; partnerships; and two or more persons having a joint or common economic interest, as well as local, state, United States or foreign governments or any other unit that requires interaction with a regulatory agency to obtain approval for goods or services. The term “regulatory agency”, as used herein, refers to a governmental body (federal, state, local, provincial, municipal, etc.) charged with administering and implementing particular legislation. Examples in the context of the United States government include the Federal Trade Commission (FTC), Federal Communication Commission (FCC), Environmental Protection Agency (EPA), and Federal Aviation Administration (FAA). One non-limiting example of an entity-agency pair would be an aircraft engine manufacturer seeking airworthiness certification from the FAA for a new engine model.

The term “electronic signature” used herein, includes any mark transmitted in computer-readable form identifying a party and intended to relate consent.

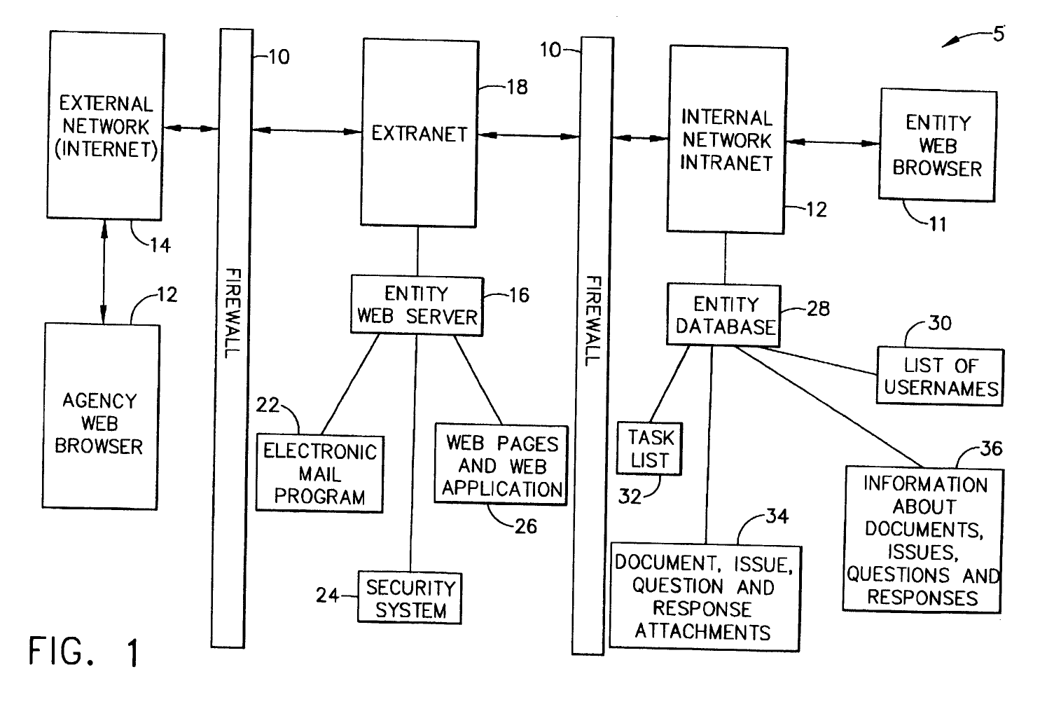

FIG. 1 illustrates an embodiment of a system 5 according to the present invention through a block diagram. The system 5 consists of a web server 16 and a database 28, both of which are protected behind at least one firewall 10. A firewall 10 is a system for protecting and isolating an internal network 12, and/or its computers, from access through an external network 14 to which the internal network 12 or computers are attached. The purpose of a firewall 10 is to allow the internal network 12 elements to be attached to, and access, other networks without rendering the internal network 12 elements susceptible to access from unauthorized individuals using the external network 14. In an embodiment of the present invention, firewalls 10 would exist between the entity and the regulatory agency's internal network databases and another firewall 10 would exist between the entity's internal network database and the web server 16. The firewalls 10 used in accordance with the present invention could be any type of firewall known in the art.

The web server 16 is hosted and maintained by the entity for use by a regulatory agency and connects the employees of an entity and the employees of the regulatory agency. The web server 16 is within an extranet system 18, which is external to the entity's internal network (Intranet) 12. The web server 16, in an embodiment of the present invention, may be an online system only accessible to the employees of the entity and the employees of the regulatory agency. The employees of both the entity and the regulatory agency have the web address or Universal Resource Locator (URL) of the web server 16 and an authorized user identity to access the system. Without both the address and authorized user identity the firewall 10 will not allow unauthorized users to use the system. The web server 16 used in accordance with the present invention can be any type of web server known in the art. The extranet web server 16 and the internal multi-function database 28 can communicate by any means known in the art. An embodiment of the present invention may use a web server and database that communicate by Java servlets.

The web server 16 may contain various parts in its preferred embodiment. The web server 16 may utilize an automatic electronic mail program 22 to notify designated users concerning the modification of the status of a document within the database 28. A modification of the documents' status, such as approval of a document, rejection of a document, modification of document's content or location, etc. could trigger an electronic mail notification to users associated with the document and may contain a hypertext link to the document that was modified. The web server may utilize a security system 24 to identify an authorized user to allow access to various functions of the system according to username or by any other means to identify the user known in the art. The web server can use any security system known in the art, such as a Lightweight Directory Access Protocol (LDAP) directory on the web server 16. The security system 24 on the web server 16 correlates the identity of the user entered with a list within in the system's directory. The identity of the user must exist in the system's directory before the security system will allow access to the system. As well, in an embodiment of the present invention, the web server 16 ma contain a series of web pages 26 containing information on products, services, and information concerning past compliance with agency regulations. The web server 16 could also connect to and communicate with a database 28 that contains information products and services of the entity.

The system also contains a database 28 that is within the internal network of the entity (Intranet) 12. The database 28 is hosted and maintained by the entity for use by the employees of the regulatory agency and employees of the entity. The database 28 connects and supplies data to the web server 16 as previously described. The database 28 used in this system can be any type of commerciall available database, such as an Oracle database. An embodiment of the present could include a multifunctional database.

The database 28 in an embodiment of the present invention may contain a list of user identities 30 that would correlate individual identities of the users with the information they are allowed to access. The database may include a personalized task list 32 which lists open action items or tasks assigned to the particular user. Individual users would have a personalized task list 32 associated with their identity that is displayed when the user is authorized to enter into the system. Other users assign the tasks and the tasks are related to obtaining approval from the regulatory agency. The personalized task 32 list would include a hypertext link to the documents associated with the assigned tasks.

The database 28 within the system can include the documents created within the web server 16 as well as previously created documents. Documents 34 can be created, edited, deleted, stored and retrieved in computer-readable form within the secure network. In an embodiment of the present invention, documents can be created within text boxes in a web form on the web server 16 and the information stored and retrieved from the database 28. The term “form” or “web form”, as used herein, refers to an HTML-based, interactive web site feature, containing any functionality such as checkboxes, option lists, text boxes, or buttons that allow users to submit information to pre-formatted pages. Also, in an embodiment of the present invention, the database 28 can store computer files containing documents created in various common applications. The term “applications”, as used herein, means software that performs a specific task or function, such as word-processing, creation of spreadsheets, or the generation of graphics. Information concerning documents, issues, questions, and responses, such as modification and documents profiles, is also stored on the database 36.

Access to the system by the agency and the entity is facilitated by an agency web browser 12 and an entity web browser 11, which can be of an commercially available type of web browser which is compatible with the other elements of the system.

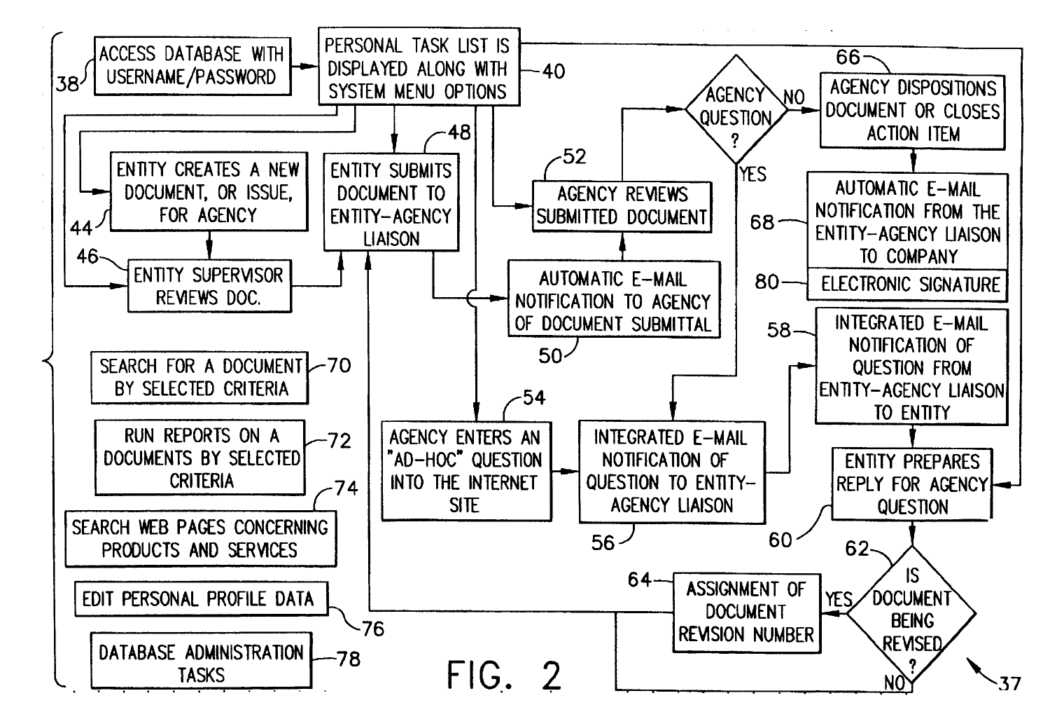

FIG. 2 illustrates an overview of a method 37 of using the computerimplemented system 5 of FIG. 1. The method 37 allows employees of the entity and the regulatory agency to collaborate for the purpose of obtaining disposition by the regulatory agency. When a user wishes to enter the network, the user types in the web address or Universal Resource Locator (URL) of the web server. The user must be identified by a web security system, such as a username and password, to access the system at step 38. The web security system correlates the identity of the user with the list of authorized users within the directory and, if the user is authorized, the user can enter the site. A password in conjunction with the username provides added assurance that the user is the individual corresponding to the username. When the user enters the site, their personal task list appears at step 40. The tasks assigned on the personalized task list will be related to obtaining disposition by the agency for a product or service. Upon viewing the personal task list at step 40, the user may proceed upon a number of different paths as shown in FIG. 2. Depending upon the identity of the user and the types of tasks presented in the task list, some navigation choices may only be available to selected users. For example, agency personnel ma only be presented with choices corresponding to agency actions and entity personnel may only be presented with choices corresponding to entity actions.

In one sequence of steps according to FIG. 2, an employee of the entity enters the system at step 38 and after viewing their personal task list at step 40 proceeds to input a document at step 44 as may be required by law, such as a document for certification of a product or service, in fulfillment of an action item on their task list shown at step 40. To input a document, the employee of the entity goes to the systems' page within the server that is used to create a document 44. The entit employee uses the fields in the web form to create the document and/or may attach computer files that are the document or related to the document itself. After the document is created or attached, the entity employee selects the appropriate supervisor that the completed document will be sent to for review and revision at step 46 before the document is submitted to the entity-agency liaison at step 48. The selected supervisor receives the request to review the newly created document in one of two ways, by automatically adding revision of document to the supervisor's personal task list on the web server and/or by an automatic electronic mail message. Both the personal task list and the e-mail message contain hypertext link to the document. The supervisor then enters the system via steps 38 and 40, then proceeds to the review step 46. The document is then sent to the entity-agency liaison at step 48. The entityagency liaison also enters the system via steps 38 and 40, then proceeds to the review step 48. After the entity-agency liaison receives the document and completes his or her review of the document, the entity-agency liaison may submit the document to the agency which generates an automatic e-mail notification to the agency at step 50. Throughout the process, any time a document, question, response, etc. is sent from one individual or role to another, whether within the entity, within the agency, or across the entity-agency border, the recipient's task list is updated and an automatic e-mail notification is sent.

As shown in FIG. 2, an agency employee can enter the system at step 38, proceed to review their personal task list at step 40, and then review the submitted document after it is received at step 52. The selected employee of the agency receives the request to review the submitted document in two ways, by automatically adding revision of the document to the agency employee's personal task list on the web server and/or by an automatic electronic mail message. Both the personal task list and the e-mail message contain hypertext links to the document. Upon review of the document, the agency employee may direct a question to the entity at step 56. An agenc employee may submit a question in a text box within a web form of a page on the web site, or by attaching a computer file, or the agency may direct questions that are unrelated to a document, so-called “ad-hoc” questions, via a selection on their task list 40 which directs them to step 54. The notification of the question from the agency is automatically electronically mailed to the entity-agency liaison at step 56. The entity-agency liaison reviews the question and transfers responsibility for the question to the appropriate employee in the entity via the system, which will notify the recipient via automatic electronic mail to the appropriate employee in the entity concerning the question 58 and place the question on their task list.

An entity employee or employees will prepare a reply to the agency 60, again via entering the system via steps 38 and 40. The entity may have to revise a previously prepared document according to the questions of the agency 62 according to step 62. The newly revised document is assigned a revision number by the agency at step 64 and is resubmitted to the entity-agency liaison via step 48 and in turn to the agency via step 50 as described above. The interaction between the entity and agenc concerning the document, question, issue, or other action item continues until the agency approves (or other disposition) the document or either the agency or entit closes the document as an action item via step 66. When the document is either dispositioned or the action item is closed there is an automatic e-mail from the entity-agency liaison to that affect at step 68. In one embodiment of the present invention, the disposition transactions between the entity and the regulatory agency are not be considered formal. Therefore, an actual paper form must be sent to the regulator agency for official approval. However, in another embodiment when an agreed-upon type of electronic signature is acceptable as a form of disposition by a regulator agency, the disposition of the regulatory agency would be formalized by the use of electronic signature at step 80 and the entire disposition transaction would be paperless.

Additional functions available from the personal task list menu at step 40 are shown at the bottom left of FIG. 2 and described hereafter. At any time within the collaboration process, the employees of both the agency and the entity ma search the records of the agency (step 70) and run reports (step 72) for documents concerning the past regulatory records and documents of the same or similar product and services using selected criteria. The employees of either the agency or the entit may search the web pages (step 74) connected to the system for more information concerning the product or service involved. The individual user may have access to edit personal account profile data (step 76). The system in a preferred embodiment will give certain individuals access to administrative tasks behind the web site (step 78) to manage account access, upload information, update functionality, etc.

While one example of a method of collaboration has been illustrated in FIG. 2, it should be understood that the method may be adapted to suit the needs of a particular agency-entity pair, and may include the need to add additional functionality, additional steps in sequence, or additional individuals who need to participate in the process. In addition, one or more other entities involved in a business relationship with the entity seeking disposition may also be involved.

While the invention has been described in terms of various specific embodiments, those skilled in the art will recognize that the invention can be practiced with modification within the spirit and scope of the claims.

What is claimed is:

1. A computer implemented system of secure transmission and collaboration of information between employees of an entity and employees of a regulatory agency for the purpose of obtaining disposition by said regulatory agency, said system comprising:
a) a web server that is behind at least one firewall, wherein said web server connects employees of said entity and employees of said regulatory agency and is maintained and hosted by said entity for use by said regulatory agency; and
b) a database that is behind at least one firewall and is connected to said web server, wherein the contents of said database are in computer-readable form within a secure network and are maintained and hosted by said entity for use b said regulatory agency.

2. The system of claim 1 further comprising a security system tocontrol access to various functions of said system according to a user's identity.

3. The system of claim 1 further comprising a series of web pages containing information concerning past compliance with agency regulations.

4. The system according to claim 1 further comprising anautomatic electronic mail program which notifies designated users of information relating to agency disposition in computer-readable form within a secure network.

5. The system according to claim 4 wherein designated users receive an electronic message containing information concerning a modification of a document's status and a hypertext link to the associated document.

6. The system according to claim 4 wherein users receive an electronic message corresponding to an assigned task including a hypertext link to the documents associated with said assigned task.

7. The system of claim 1 wherein said database contains information concerning products and services.

8. The system of claim 1 wherein documents can be created, edited, deleted, stored and retrieved in computer-readable form within a secure network.

9. The system of claim 1 wherein a personalized index of tasks is stored and retrievable in computer readable form within a secure network and is displayed when a user's identity is authorized.

10. The system according to claim 9 wherein a document associated with an assigned task is hypertext linked to the personalized task list.

11. The system of claim 1 wherein approval from the agency is formalized by use of an electronic signature.

12. A computer implemented method of secure transmission and collaboration of information between employees of an entity and employees of a regulatory agency for the purpose of obtaining disposition by said regulatory agency, said method comprising the steps of:
a) collecting and storing information concerning regulator approval;
b) establishing, hosting and maintaining a database of said information;
c) establishing and maintaining a secure environment for said database;
d) providing the employees of said regulatory agency with authorization to obtain said information from said database;
e) providing the employees of said regulatory agency with the capability to request information from said database;
f) providing the employees of said regulatory agency the capability to add information to said database; and
g) providing the employees of said regulatory agency the capability to modify said information within said database.

13. The method of 12 further comprising the step of utilizing asecurity system to control access to various functions of the system according to a user's identity.

14. The method according to claim 12 further comprising the step of searching a series of web pages for information concerning past compliance with agency regulations.

15. The method of claim 12 further comprising the steps of creating, editing, deleting, storing and retrieving documents in computer-readable form within secure network.

16. The method of claim 12 further comprising the step of displaying a personalized index of tasks relating to obtaining disposition from a regulatory agency.

17. A method of claim 12 further comprising the step of assigning tasks to users relating to receiving agency approval.

18. The method of claim 12 further comprising the step of utilizing an automatic electronic mail program which notifies designated users of information relating to agency approval.

19. The method of claim 12 further comprising the step of searching for a document relating to obtaining approval from a regulatory agency.

20. The method of claim 12 further comprising the step of formalizing approval from the agency with an electronic signature.
